(19) United States
(12) Patent Application Publication
(10) Pub. No.: US 2024/0152794 A1
(43) Pub. Date: May 9, 2024

(54) Mitigation of Qubit Crosstalk-Induced Errors in Quantum Computing and Information Processing Systems

(71) Applicant: Google LLC, Mountain View, CA (US)

(72) Inventors: Benjamin Thomas Chiaro, Goleta, CA (US); Zijun Chen, Seattle, WA (US); Kenny Lee, Mountain View, CA (US)

(21) Appl. No.: 17/974,216

(22) Filed: Oct. 26, 2022

(51) Int. Cl. G06N 10/70

(52) U.S. Cl. CPC G06N 10/70

(57) ABSTRACT

The disclosure is directed towards mitigation of qubit crosstalk-induced errors within a quantum computing system (QCS). A compensating signal is provided to one or more qubits. The compensating signal at least partially “cancels-out” (e.g., compensates for) the crosstalk between pairs of qubits. Such crosstalk-induced errors may include leakage of a qubit's quantum state out of the quantum system's computational subspace. Thus, the embodiments may be employed to decrease quantum computational errors occurring from a qubit transitioning (or leaking) to an excited state that is not within the quantum system's computational subspace.

### FIELD

The present disclosure relates generally to quantum computing and information processing systems, and more particularly to the mitigation of qubit crosstalk-induced errors in quantum computing and information processing systems.

### BACKGROUND

Quantum computing is a computing method that takes advantage of quantum effects, such as superposition of basis states and entanglement to perform certain computations more efficiently than a classical digital computer. In contrast to a digital computer, which stores and manipulates information in the form of bits, e.g., a “1” or “0,” quantum computing systems can manipulate information using quantum bits (“qubits”). A qubit can refer to a quantum device that enables the superposition of multiple states, e.g., data in both the “0” and “1” state, and/or to the superposition of data, itself, in the multiple states. In accordance with conventional terminology, the superposition of a “0” and “1” state in a quantum system may be represented, e.g., as a |0 [symbol] +b|1 [symbol] The “0” and “1” states of a digital computer are analogous to the |0 [symbol] and |1 [symbol] basis states, respectively of a qubit.

### SUMMARY

Aspects and advantages of embodiments of the present disclosure will be set forth in part in the following description, or can be learned from the description, or can be learned through practice of the embodiments.

One example aspect of the present disclosure is directed to a method implemented by a quantum computing system (QCS). The QCS may include a set of qubits. The method may be for calibrating a compensating signal that is employed to mitigate qubit crosstalk-induced errors in a quantum computation. The method may include determining a selected pulse delay for consecutive pulses of a series of qubit rotation pulses that are applied to each qubit of the set of qubits. Each qubit rotation pulse of the series of qubit rotation pulses applied to a qubit of the set of qubits may generate a rotation of a quantum state of the qubit. The selected pulse delay may increase a probability of the applied series of qubit rotation pulses generating a leakage of at least a portion of the set of qubits from a computational subspace of the QCS to an excited subspace of the QCS. The selected pulse delay may be an optimal pulse delay. As an optimal pulse delay, the selected pulse delay may at least approximately maximize the probability of the applied series of qubit rotation pulses generating a leakage of at least a portion of the set of qubits from a computational subspace of the QCS to an excited subspace of the QCS. Based on the selected pulse delay, a pair of qubits of the set of qubits may be identified. The identified pair of qubits may contribute to the leakage of the portion of the set of qubits from the computational subspace to the excited subspace. The pair of qubits may include a source qubit and a receiver qubit. The identified pair of qubits may be employed to determine values for a set of compensating parameters for a compensating signal. When a control signal is provided to the source qubit and the compensating signal is provided to the receiver qubit, a probability of the control signal generating a leakage of the receiver qubit from the computational subspace to the excited subspace is decreased.

Other aspects of the present disclosure are directed to various systems, methods, apparatuses, non-transitory computer-readable media, computer-readable instructions, and computing devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, explain the related principles.

### BRIEF DESCRIPTION OF THE DRAWINGS

Detailed discussion of embodiments directed to one of ordinary skill in the art is set forth in the specification, which refers to the appended figures, in which:

FIG. 1 depicts an example quantum computing system according to example embodiments of the present disclosure.

FIG. 2A depicts an example first qubit that is in accordance with various embodiments.

FIG. 2B depicts an example second qubit that is positioned in close proximity to the first qubit of FIG. 2A, in accordance with various embodiments.

FIG. 2C depicts parasitic electromagnetic couplings between the first qubit and the second qubit of FIG. 2B, in accordance with various embodiments.

FIG. 2D depicts an induced leakage of the second qubit of FIGS. 2B-2C out of a computational subspace and into an excited subspace that is induced by the first control signal of FIGS. 2B-2C.

FIG. 2E depicts a mitigation of the induced leakage out of a computational subspace of FIG. 2D via an application of a compensating signal to the second qubit, according to various embodiments.

FIG. 3A depicts a Ramsey error filter pulse sequence applied to qubits to calibrate compensating signals for the mitigation of qubit crosstalk-induced errors, in accordance with various embodiments.

FIG. 3B shows representative data from the Ramsey error filter vs delay time, in accordance with various embodiments.

FIG. 3C shows typical output of the Ramsey error filter at optimal pulse delay during pairwise operation for all possible pairs that include the receiver qubit.

FIG. 3D shows the leakage probability for the receiver qubit during pairwise operation with the dominant source qubit at optimal pulse delay vs the amplitude and phase shift of the compensating signal.

FIG. 4 provides a flowchart for a method of calibrating compensating signals for the mitigation of qubit crosstalk-induced errors, in accordance with various embodiments.

FIG. 5 provides a flowchart for a method for mitigating qubit crosstalk-induced errors in a quantum computing system, in accordance with various embodiments.

### DETAILED DESCRIPTION

The embodiments are directed towards obviating and/or the mitigation of computational errors within a quantum computing and/or information processing system. The embodiments target obviating and/or mitigation of qubit crosstalk-induced errors in a quantum computing system (or device) that comprises a set of qubits that includes at least a first qubit and a second qubit. The embodiments obviate and/or mitigate the qubit crosstalk-induced errors by providing a compensating signal to one or more qubits. The compensating signal at least partially “cancels-out” (e.g., compensates for) the crosstalk between pairs of qubits. Thus, a compensating signal may be referred to as a cancelling signal (or tone). Such crosstalk-induced errors may include leakage of a qubit's quantum state out of the quantum system's computational subspace. Thus, the embodiments may be employed to decrease quantum computational errors occurring from a qubit transitioning (or leaking) to an excited state that is not within the quantum system's computational subspace.

In addition to providing compensating signals that obviate and/or mitigate some quantum computational errors, the embodiments provide methods for characterizing the crosstalk between pairs of qubits. Such characterizing of the crosstalk enables calibrating of the compensating signal for any pair of qubits as a function of the parameters of a control signal intended for one of the qubits of the pair. The embodiments provide such characterizing of crosstalk and calibrating of crosstalk compensating signals by methods directed towards Ramsey interferometry measurements. That is, the transition frequencies associated with quantum state transitions of the qubits may be determined as a function of the tunings of the qubits. The compensating signals (and which qubits to provide the compensating signals) are calibrated in view of the Ramsey interferometry measurements.

To control (or tune) each qubit of the set of qubits of a quantum computing system (QCS), each qubit of the set of qubits may have a separate and independently addressable control line. That is, to control (or tune) a first qubit (e.g., of the QCS's set of qubits), a first control signal may be provided to the first qubit via a first control line terminating at the first qubit. Similarly, to control a second qubit (e.g., of the QCS's set of qubits), a second control signal may be provided to the second qubit via a second control line terminating at the second qubit Due to their physical proximity of the first and second qubits (and/or the first and second control lines) on a device implementing the set of qubits (and/or the associated control lines), the first and second qubits (and/or their associated control lines) may be electromagnetically coupled via parasitic capacitance, parasitic inductance, and/or other such electromagnetic (EM) coupling mechanisms. Thus, when EM signals of sufficient frequency are transmitted to and/or from the first and second qubits, the first and second qubits (and/or their associated control lines) may be prone to “crosstalk.” Such crosstalk between the first and second qubits may include unintentionally inducing an unwanted signal on a control line that is not associated with the qubit that the control signal is intended to control. That is, when a first control signal is provided to the first qubit via the first control line, at least a portion of the first control signal may couple to or parasitically drive (e.g., “leak” onto) the second control line and/or otherwise be provided to the second qubit. The induced (or leaked) signal may cause inadvertent operations within qubits, resulting in computational errors. The embodiments are directed towards obviating these qubit errors induced via such crosstalk. Note that physical adjacency of qubits or qubit control lines may not be required to result in unwanted crosstalk. Due to various EM coupling mechanisms, the qubits and/or control lines need not be physical adjacent for crosstalk. The qubits and/or control lines just need to be sufficiently close such that a EM coupling mechanism is strong enough to induce unwanted cross talk. Thus, as used herein, the term physical proximity (e.g., referring to qubits and/or control lines) is used to describe a situation where the qubits and/or control lines are physically “close enough” such that an EM coupling mechanism is strong enough to induce unwanted crosstalk. The term “leakage” may refer to a situation when an EM coupling mechanism induces crosstalk in a way that disrupts the expected or intended behavior of a qubit and/or a control line. That is, when unwanted and/or united crosstalk occurs, it may be described as leakage.

Such crosstalk-induced errors may include inadvertently causing the second qubit to transition (or leak) the quantum state of one or more qubits out of the computational subspace of the QCS. In non-limiting embodiments, a QCS rely on each of the qubits of its set of qubits being in either a “pure” state of one of its two lowest eigenstates (e.g., |0 [symbol] and |1 [symbol] ) or a superposition of its pure states (e.g., α₀|0 [symbol] +α₁|1 [symbol] ), where α₀ and α₁∈C subject to the constraint α*₀·α₀+α*₁·α₁=1. The qubit's pure state |0 [symbol] may be referred to as the qubit's ground state, while the qubit's other pure state |1 [symbol] may be referred to as the qubit's first excited state. Accordingly, the computational subspace of such a QCS includes the tensor product of: {|0 [symbol] , |1 [symbol] }₁⊗{|0 [symbol] , |1 [symbol] }₂⊗ . . . ⊗{|0 [symbol] , |1 [symbol] }_{N}, where N is a positive integer that indicates the cardinality (or size) of the set of qubits. However, the quantum state space of many QCSs may be larger than the computational subspace. For instance, some QCSs implement qubits with systems (or particles) that have additional quantum eigen states (e.g., additional excited states). Some QCSs implement qubits via transmons, which are quantum circuits implemented via a pair of superconducting Josephson junctions. A transmon may be modeled as a quantum harmonic oscillator (QHO) with an infinite number of eigenstates: |0 [symbol] , |1 [symbol] , |2 [symbol] , |3 [symbol] . . . , where the eigenstates: |2 [symbol] , |3 [symbol] . . . are excited states associated with energies (or frequencies) greater than the first excited state: |1 [symbol] . The eigenstate |2 [symbol] may be referred to as the qubit's second eigenstate, the eigenstate |3 [symbol] may be referred to as the qubit's third eigenstate, and so on. Note that in other embodiments, a QCS may employ higher excited qubit states than just the first excited state, e.g., |1 [symbol] . For instance, a QCS may compute with qubit states: 0 [symbol] , |1 [symbol] , |2 [symbol] , or other non-limiting ranges of states. Thus the term computational subspace may refer to 0 [symbol] , |1 [symbol] , |2 [symbol] , or other such ranges. The term computational subspace may refer to any set of qubit states that are employed for computation by the QCS, and the term excited subspace may refer to a disjoint set of qubit states that are not employed for computation by the QCS. For example, in one non-limiting embodiment, a computation subspace may include the set of qubit sates {0 [symbol] , |1 [symbol] } while the excited subspace includes the set of qubit states {2 [symbol] , |3 [symbol] , . . . }. In another non-limiting embodiment, the term computational subspace may refer to the set of qubit states {3 [symbol] , |4 [symbol] , . . . }. The terms computational subspace and excited subspace may be defined for other ranges of qubit states, depending on the ranges employed by the QCS. The term qubit subspace may refer to the ser of qubit states: {0 [symbol] , |1 [symbol] }. The terms excited subspace and leakage subspace may be used interchangeably within.

The induced signal (or leakage) signal may induce a qubit into its second excited state, or even excited states beyond the second excited state. When at least one qubit has transitioned to a second (or higher) excited state, the qubit may be said to have transitioned (or leaked) to an excited subspace of the QCS. Note that there is no intersection of the computational subspace of the QCS and the excited subspace of the QCS. When a qubit has transitioned to the excited subspace of the QCS, the qubit may not be reliable employed for a quantum computation. Accordingly, when the first qubit is driven (or operated) via a first control signal, an induced signal may be delivered to the second qubit, causing mthe second qubit to transition (or leak) from the computational subspace to the excited subspace of the QCS. When this occurs, at least the second qubit may not be employed for quantum computations, resulting in qubit crosstalk-induced quantum errors. In some embodiments, the qubit may not be suitable for high performance quantum computations.

More specifically, when the first qubit is driven by a first control signal (e.g., a microwave control signal) over the first qubit's control line, the second qubit may be unintentionally driven (or controlled) by an induced signal (e.g., induced via crosstalk) on the second qubit's associated control line (e.g., the second control line). That is, due to physical proximity between the first and second qubits (and/or their associated control lines), quantum computational errors may be induced via the crosstalk (e.g., parasitic coupling and/or leakage) between the first and second qubits. The embodiments obviate at least a portion of such qubit crosstalk-induced errors by providing the second qubit with a second control signal (e.g., a compensating control signal) that “cancels out” (e.g., compensates) for the portion of the first control signal that is leaked (via the parasitic capacitance) to the second qubit. That is, when the first qubit is driven by the first control signal, the embodiments may provide a second control signal (e.g., the compensating signal) to the second qubit. The second control signal provided to the second qubit may at least partially compensate for the leakage of the first control signal to the second qubit. That is, the second control signal at least partially compensates for the leakage of the first control signal onto the second qubit, obviating a potential crosstalk-induced error of the second qubit.

Throughout, the first qubit (e.g., the qubit intended to be controlled with the first control signal) may be referred to as a source qubit. Because the second qubit (e.g., the qubit that is “accidently” controlled via the first control signal) is the target of the second control signal (e.g., the compensating signal), the second qubit may be referred to as a target qubit. The first control signal driving the source qubit may be referred to as a source signal, while the second control signal may be referred to as the compensating signal. In some embodiments, the source qubit may be referred to as an antagonist qubit and the portion of the first signal that is leaked (or induced) to the target qubit may be interchangeably referred to as an antagonist signal, a leakage signal, an induced signal, and/or a parasitic signal. Note that driving a single source qubit via a source signal may accidently result in multiple target qubits that are inadvertently driven by the source signal leaking onto the multiple target qubits' drive lines. Each of the multiple target qubits may be provided their own compensating signal to obviate errors in each of the multiple target qubits.

In addition to methods for obviating such crosstalk-induced errors by providing the compensating signal to the second qubit, the embodiments provide methods for calibrating such compensating signals. Such methods may employ Ramsey interferometry measurements, that characterize the transition frequencies and phase shifts associated with transitioning a qubit into one of its excited states beyond its first excited states. That is, such calibration methods may be based on a Ramsey error filter procedure that determines values for a set of compensating parameters that parameterize (or characterize) the compensating signal. One example method is a method for calibrating a compensating signal that is employed to mitigate qubit crosstalk-induced errors in a quantum computation, as discussed throughout. The calibration method may be implemented by a QCS. The QCS may include a set of qubits. The method may include determining a selected pulse delay for consecutive pulses of a series of qubit rotation pulses that are applied to each qubit of the set of qubits. Note that the terms “pulse delay” and “time delay” may be used throughout interchangeably. Each qubit rotation pulse of the series of qubit rotation pulses applied to a qubit of the set of qubits may generate a rotation of a quantum state of the qubit. The selected pulse delay may increase a probability of the applied series of qubit rotation pulses generating a leakage of at least a portion of the set of qubits from a computational subspace of the QCS to an excited subspace of the QCS. The selected pulse delay may be an optimal pulse delay. As an optimal pulse delay, the selected pulse delay may at least approximately maximize the probability of the applied series of qubit rotation pulses generating a leakage of at least a portion of the set of qubits from a computational subspace of the QCS to an excited subspace of the QCS. Each qubit rotation pulse of the series of rotation pulses applied to the qubit may be a pi-rotation pulse. A pi-rotation pulse may generate a rotation of the quantum state of the qubit. The generated rotation of the quantum state may be a rotation about at least one of an x-axis or a y-axis of a Bloch sphere representation of the quantum state of the qubit.

The method may additionally include identifying, based on the selected pulse delay, a pair of qubits of the set of qubits. The identified pair of qubits may contribute to the leakage of the portion of the set of qubits from the computational subspace to the excited subspace. The pair of qubits may include a source qubit and a receiver qubit. The identified pair of qubits may be a pair of qubits from all possible pairings of the set of qubits that dominates the leakage of the portion of the set of qubits from the computational subspace to the excited subspace.

The method may further include employing the identified pair of qubits to determine values for a set of compensating parameters for a compensating signal. The set of compensating parameters may include a first parameter corresponding to a magnitude of the compensating signal and a second parameter corresponding to a phase of the compensating signal. When a control signal is provided to the source qubit and the compensating signal is provided to the receiver qubit, a probability of the control signal generating a leakage of the receiver qubit from the computational subspace to the excited subspace is decreased. The values for the set of compensating parameters for the compensating signal may be selected from a space of possible values for the set of compensating parameters. The selected values may be values from the space of possible values that minimize the probability of the control signal generating a leakage of the receiver qubit from the computational subspace to the excited subspace. The leakage of the receiver qubit from the computational subspace to the excited subspace may include a transition of a quantum state of the receiver qubit from a first excited state to a second excited state. Providing the compensating signal to the receiver qubit may compensate for an induced signal that is provided to the receiver qubit. The induced signal may be induced from the control signal being provided to the source qubit. The compensating signal prevents the leakage of the receiver qubit from the computational subspace to the excited subspace that the induced signal would otherwise cause.

The embodiments include another method implemented by a QCS. The other method may be a method for mitigating qubit crosstalk-induced errors during a quantum computation. The method may include in order to perform a quantum computation by the QCS, determining that a control signal is to be provided to a source qubit of the set of qubits. In response to determining that the control signal is to be provided to the source qubit, the control signal may be provided to the source qubit. Also in response to determining that the control signal is to be provided to the source qubit, a compensating signal may be provided to a receiver qubit of the set of qubits. The provided compensating signal may be in accordance with (e.g., based on) values for a set of compensating parameters. The values for the set of compensating parameters may be determined such that providing the compensating signal to the receiver qubit compensates for an induced signal that is provided to the receiver qubit. The induced signal may be induced from the control signal being provided to the source qubit. The compensating signal may prevent a leakage of the receiver qubit from a computational subspace of the QCS to an excited subspace of the QCS that the induced signal would otherwise cause.

The values for the set of compensating signals may be determined in accordance to any of the various embodiments discussed herein. For instance, the values for the set of compensating parameters may be determined based on a Ramsey error filter procedure.

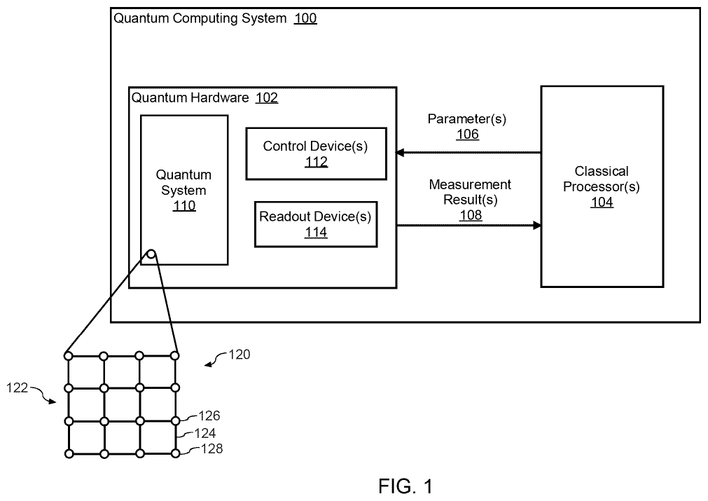

The embodiments include a quantum computing system (QCS) (e.g., a quantum computing and/or quantum information processing device). Various embodiments of a QCS are discussed in conjunction with at least FIG. 1. However, briefly here, the QCS may include a set of qubits, one or more processor devices (e.g., classical processor devices, quantum processor devices, or a combination thereof), and one or more memory devices. The one or more memory devices may store computer-readable instructions. When the instructions are executed by the one or more processors, the one or more processors may be caused to perform operations. The operations may include determining a selected pulse delay for consecutive pulses of a series of qubit rotation pulses that are applied to each qubit of the set of qubits. Each qubit rotation pulse of the series of qubit rotation pulses applied to a qubit of the set of qubits may generate a rotation of a quantum state of the qubit. The selected pulse delay may increase a probability of the applied series of qubit rotation pulses generating a leakage of at least a portion of the set of qubits from a computational subspace of the QCS to an excited subspace of the QCS. The selected pulse delay may be an optimal pulse delay. As an optimal pulse delay, the selected pulse delay may at least approximately maximize the probability of the applied series of qubit rotation pulses generating a leakage of at least a portion of the set of qubits from a computational subspace of the QCS to an excited subspace of the QCS. The operations may further include identifying, based on the selected pulse delay, a pair of qubits of the set of qubits. The identified pair of qubits may contribute to the leakage of the portion of the set of qubits from the computational subspace to the excited subspace. The pair of qubits may include a source qubit and a receiver qubit. The operations may further include employing the identified pair of qubits to determine values for a set of compensating parameters for a compensating signal, wherein when a control signal is provided to the source qubit and the compensating signal is provided to the receiver qubit, a probability of the control signal generating a leakage of the receiver qubit from the computational subspace to the excited subspace is decreased.

Aspects of the present disclosure provide a number of technical effects and benefits. For instance, the embodiments mitigate (or obviate) errors (e.g., qubit crosstalk-induced errors) in a quantum computation performed by a QCS and/or a quantum computing device. Thus, the performance a QCS that employs the embodiments is clearly improved because the QCS is less prone to errors while carrying out a quantum computation.

FIG. 1 depicts an example quantum computing system 100. The quantum computing system 100 is an example of a system of one or more classical computers and/or quantum computing devices in one or more locations, in which the systems, components, and techniques described below can be implemented. Those of ordinary skill in the art, using the disclosures provided herein, will understand that other quantum computing devices or systems can be used without deviating from the scope of the present disclosure.

The quantum computing system 100 includes quantum hardware 102 in data communication with one or more classical processors 104. The classical processors 104 can be configured to execute computer-readable instructions stored in one or more memory devices to perform operations, such as any of the operations described herein. The quantum hardware 102 includes components for performing quantum computation. For example, the quantum hardware 102 includes a quantum system 110, control device(s) 112, and readout device(s) 114 (e.g., readout resonator(s)). The quantum system 110 can include one or more multi-level quantum subsystems, such as a register of qubits (e.g., qubits 120). In some implementations, the multi-level quantum subsystems can include superconducting qubits, such as flux qubits, charge qubits, transmon qubits, gmon qubits, spin-based qubits, and the like.

The type of multi-level quantum subsystems that the quantum computing system 100 utilizes may vary. For example, in some cases it may be convenient to include one or more readout device(s) 114 attached to one or more superconducting qubits, e.g., transmon, flux, gmon, xmon, or other qubits. In other cases, ion traps, photonic devices or superconducting cavities (e.g., with which states may be prepared without requiring qubits) may be used. Further examples of realizations of multi-level quantum subsystems include fluxmon qubits, silicon quantum dots or phosphorus impurity qubits.

Quantum circuits may be constructed and applied to the register of qubits included in the quantum system 110 via multiple control lines that are coupled to one or more control devices 112. Example control devices 112 that operate on the register of qubits can be used to implement quantum gates or quantum circuits having a plurality of quantum gates, e.g., Pauli gates, Hadamard gates, controlled-NOT (CNOT) gates, controlled-phase gates, T gates, multi-qubit quantum gates, coupler quantum gates, etc. The one or more control devices 112 may be configured to operate on the quantum system 110 through one or more respective control parameters (e.g., one or more physical control parameters). For example, in some implementations, the multi-level quantum subsystems may be superconducting qubits and the control devices 112 may be configured to provide control pulses to control lines to generate magnetic fields to adjust the frequency of the qubits.

The quantum hardware 102 may further include readout devices 114 (e.g., readout resonators). Measurement results 108 obtained via measurement devices may be provided to the classical processors 104 for processing and analyzing. In some implementations, the quantum hardware 102 may include a quantum circuit and the control device(s) 112 and readout devices(s) 114 may implement one or more quantum logic gates that operate on the quantum computing system 100 through physical control parameters (e.g., microwave pulses) that are sent through wires included in the quantum hardware 102. Further examples of control devices include arbitrary waveform generators, wherein a DAC (digital to analog converter) creates the signal.

The readout device(s) 114 may be configured to perform quantum measurements on the quantum system 110 and send measurement results 108 to the classical processors 104. In addition, the quantum hardware 102 may be configured to receive data specifying physical control qubit parameter values 106 from the classical processors 104. The quantum hardware 102 may use the received physical control qubit parameter values 106 to update the action of the control device(s) 112 and readout devices(s) 114 on the quantum system 110. For example, the quantum hardware 102 may receive data specifying new values representing voltage strengths of one or more DACs included in the control devices 112 and may update the action of the DACs on the quantum system 110 accordingly. The classical processors 104 may be configured to initialize the quantum system 110 in an initial quantum state, e.g., by sending data to the quantum hardware 102 specifying an initial set of physical control qubit parameters 106.

In some implementations, the readout device(s) 114 can take advantage of a difference in the impedance for the |0 [symbol] and |1 [symbol] states of an element of the quantum system, such as a qubit, to measure the state of the element (e.g., the qubit). For example, the resonance frequency of a readout resonator can take on different values when a qubit is in the state |0 [symbol] or the state |1 [symbol] , due to the nonlinearity of the qubit. Therefore, a microwave pulse reflected from the readout device 114 carries an amplitude and phase shift that depend on the qubit state. In some implementations, a Purcell filter can be used in conjunction with the readout device(s) 114 to impede microwave propagation at the qubit frequency.

In some embodiments, the quantum system 110 can include a plurality of qubits 120 arranged, for instance, in a two-dimensional grid 122. For clarity, the two-dimensional grid 122 depicted in FIG. 1A includes 4×4 qubits, however in some implementations the quantum system 110 may include a smaller or a larger number of qubits. In some embodiments, the multiple qubits 120 can interact with each other through multiple qubit couplers, e.g., qubit coupler 124. The qubit couplers can define nearest neighbor interactions between the multiple qubits 120. In some implementations, the strengths of the multiple qubit couplers are tunable parameters. In some cases, the multiple qubit couplers included in the quantum computing system 100 may be couplers with a fixed coupling strength.

In some implementations, the multiple qubits 120 may include data qubits, such as qubit 126 and measurement qubits, such as qubit 128. A data qubit is a qubit that participates in a computation being performed by the quantum computing system 100. A measurement qubit is a qubit that may be used to determine an outcome of a computation performed by the data qubit. That is, during a computation an unknown state of the data qubit is transferred to the measurement qubit using a suitable physical operation and measured via a suitable measurement operation performed on the measurement qubit.

In some implementations, each qubit in the multiple qubits 120 can be operated using respective operating frequencies, such as an idling frequency and/or an interaction frequency and/or readout frequency and/or reset frequency. The operating frequencies can vary from qubit to qubit. For instance, each qubit may idle at a different operating frequency. The operating frequencies for the qubits 120 can be chosen before a computation is performed.

FIG. 1 depicts one example quantum computing system that can be used to implement the methods and operations according to example aspects of the present disclosure. Other quantum computing systems can be used without deviating from the scope of the present disclosure.

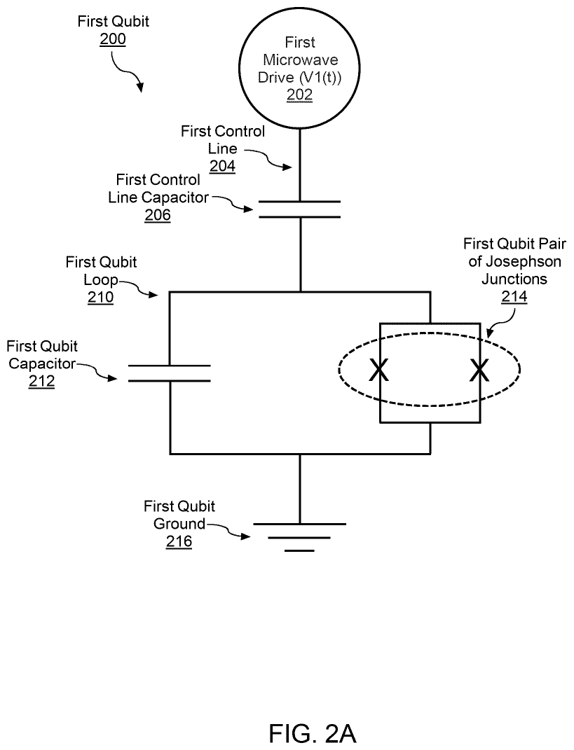

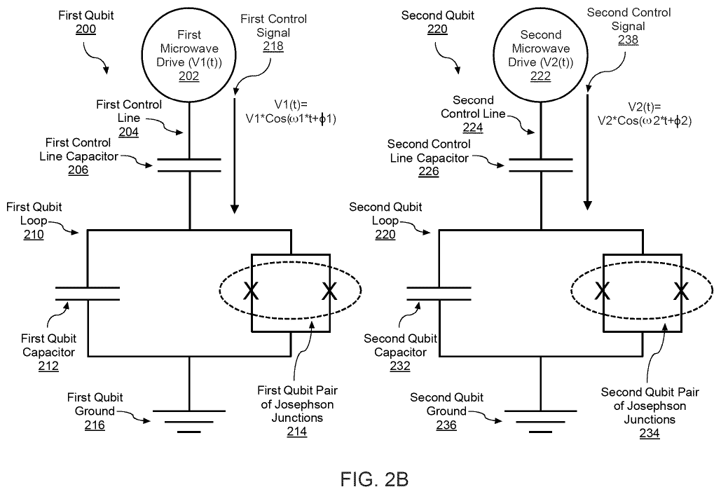

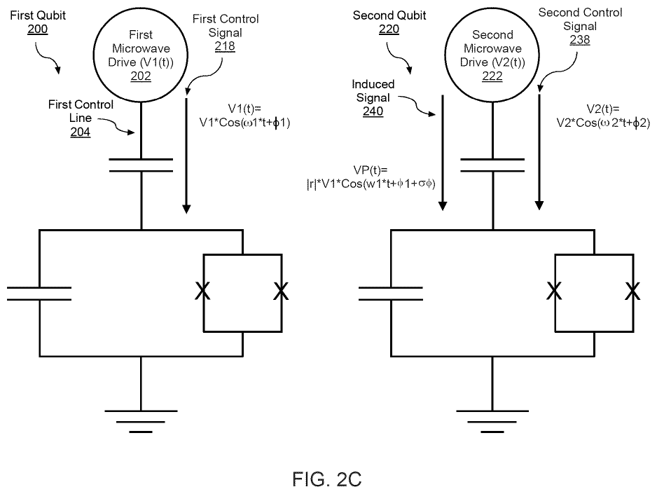

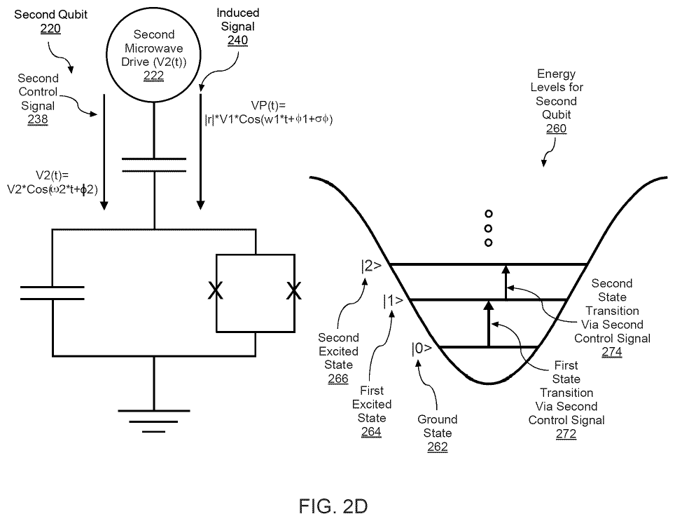

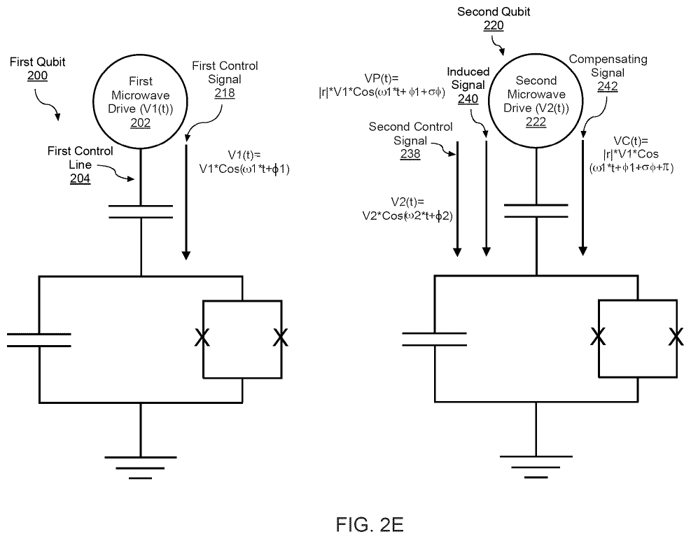

FIG. 2A depicts an example first qubit 200 that is in accordance with various embodiment. First qubit 200 may be a transmon qubit (e.g., a qubit that is implemented by a transmon superconducting circuit). The transmon circuit implementing first qubit 200 may include a first microwave drive 202 that drives a first control signal (e.g., a first microwave pulse V₁(t)) along a first control line 204. The first control signal may be transmitted to the first qubit 200 via the first control line 204. To control the transmission of the first control signal to the first qubit 200, a first control line capacitor 206 may be positioned along the first control line 204. That is, the first control line capacitor 206 may capacitively couple the transmission of the first control signal to the first qubit 200. The first control line 204 may terminate at a first qubit loop 210 of the transmon circuit. The first qubit loop 210 includes a first qubit capacitor 212 and a first qubit pair of Josephson junctions 214. The first qubit loop 210 may be tied to a first qubit ground 216 such that the first qubit 200 is not floating.

In various embodiments, a qubit (e.g., the first qubit 200 and/or the second qubit 220 of FIG. 2B) may be employed to implement a quantum logic gate (e.g., a Pauli-X gate, a Pauli-Y gate, a Pauli-Z gate, a Hadamard gate, or the like). In other embodiments, the first qubit 200 (and/or the second qubit 220) may be employed as an information encoding mechanism for a quantum computation. Whether employed as a quantum logic gate or an information encoding mechanism, a quantum computing system (QCS), such as but not limited to quantum computing system 100 of FIG. 1 may employ the first qubit 200 and/or the second qubit 220 in a performance of a quantum computation and/or quantum information processing process. Controlling the amplitude and phase of the first control signal (e.g., V₁(t)) may selectively enable the implementation of the quantum logic gate and/or enable the first qubit 200 as an information encoding mechanism. As noted above, the first control line capacitor 206 may capacitively couple the first control signal (e.g., a microwave pulse) to the first qubit 200. Thus, a first microwave pulse enables a first quantum logic gate and/or a first information encoding mechanism.

FIG. 2B depicts an example second qubit 220 that is positioned in close proximity to the first qubit 200 of FIG. 2A, in accordance with various embodiments. For instance, the first qubit 200 and the second qubit 220 may be positioned on a quantum integrated circuit (QIC). Second qubit 220 may be equivalent (or at least similar) to first qubit 200. In some embodiments, the qubits (e.g., the first qubit 200 and the second qubit 220) may be of equivalent, similar, or non-identical architecture that is similar enough to present the possibility of crosstalk. As such, the second qubit 220 may be a transmon qubit. In other embodiments, the second qubit 220 may not be a transmon qubit, but the possibility of crosstalk between the first qubit 200 and the second qubit 220 may cause concern. Similar to first qubit 200, the transmon circuit implementing the second qubit 220 may include a second microwave drive 222 that drives a second control signal (e.g., a second microwave pulse V₂(t)) along a second control line 224. The second control signal may be transmitted to the second qubit 220 via the second control line 224. To control the transmission of the second control signal to the second qubit 220, a second control line capacitor 226 may be positioned along the second control line 224. The second control line 224 may terminate at a second qubit loop 230 of the transmon circuit. The second qubit loop 230 includes a second qubit capacitor 232 and a second qubit pair of Josephson junctions 234. The second qubit loop 230 may be tied to a second qubit ground 236.

A first control signal 218 (e.g., a microwave pulse that is transmitted along the first control line 204 to control the first qubit 200) is shown on FIG. 2B as an arrow transmitted along the first control line 204 of the first qubit 200. The first control signal 218 has the general functional form (e.g., as a function of time): V₁(t)=V₁·cos(ω₁·t+ϕ₁), where V₁ indicates the magnitude of the first control signal 218, ω₁ indicates the frequency of the first control signal 218, and ϕ₁ indicates a phase shift associated with the first control signal 218. Likewise, the second control signal 238 (e.g., a microwave pulse that is transmitted along the second control line 224 to control the second qubit 220) is shown on FIG. 2B as an arrow transmitted along the second control line 224 of the second qubit 220. The second control signal 238 has the general functional form V₂(t)=V₂·cos(ω₂·t+ϕ₂), where V₂ indicates the magnitude of the second control signal 238, ω₂ indicates the frequency of the second control signal 238, and ϕ₂ indicates a phase shift associated with the second control signal 238. In various embodiments, the values for the parameters of the first control signal 218 (e.g., V₁, ω₁, ϕ₁) are calibrated (or tuned) to various properties of the first qubit 200, while the values for the parameters of the second control signal 238 (e.g., V₂, ω₂, ϕ₂) are calibrated (or tuned) to various properties of the second qubit 220.

FIG. 2C depicts parasitic electromagnetic (EM) couplings between the first qubit 200 and the second qubit 220 of FIG. 2B, in accordance with various embodiments. That is, FIG. 2C demonstrates a parasitic EM coupling between the first qubit 200 and the second qubit 220, where the first control signal 218 (e.g., for driving the first qubit 200) is parasitically coupled to the second qubit 220. The parasitic EM coupling of the first control signal 218 to the second qubit 220 generates an induced signal 240 (e.g., a leakage signal or an antagonist signal) along the second control line 224. The induced signal 240 follows the generalized form of the first control signal 218, with a modification (e.g., a reduction) to the first control signal's 218 amplitude and phase shift. Therefore, the generalized functional form of the induced signal 240 takes the form of V_{P}(t)=|r|·V₁·cos cos(ω₁·t+ϕ₁+δ_{ϕ}), where |r|<1 indicates a reduction in the first control signal's 218 magnitude (e.g., due to the weak parasitic coupling between the two qubits), δ_{ϕ} indicates the additional phase shift introduced via the parasitic coupling, and the subscript P indicates the parasitic (or induced) signal.

FIG. 2D depicts an induced leakage (or transition) of the second qubit 220 of FIGS. 2B-2C out of a computational subspace and into an excited subspace that is induced by the first control signal of FIGS. 2B-2C. As noted throughout, a transmon qubit (e.g., first qubit 200 and/or the second qubit 220) may be modeled as a quantum harmonic oscillator (QHO). The potential energy well and the energy levels 260 of the potential energy well for the second qubit (modeled as a QHO) are shown in FIG. 2D. The energy levels 260 for the second qubit 220 include at least the ground state 262 (e.g., indicated as the eigenstate |0 [symbol] ), the first excited state 264 (e.g., indicated as the eigenstate |1 [symbol] ), and the second excited state 266 (e.g., indicated as the eigenstate |2 [symbol] ). For simplicity, higher excited states of the second qubit 220 exists but are omitted from FIG. 2D. The ground state 262 and the first excited state 264 may be within a computational subspace of a QCS employing the second qubit 220, while the second excited state 266 (and higher excited states) are outside the computational subspace. That is, the second excited state 266 may be within an excited subspace. The excited subspace may include quantum states associated with the second excited state 266, as well as any higher excited states not shown in FIG. 2D (e.g., |3 [symbol] , 4 [symbol] , |5 [symbol] . . . ).

In some embodiments, the second control signal 238 may be tuned to cause a first quantum state transition 272 (via a resonance phenomenon associated with QHO) from the ground state 262 to the first excited state 264. The induced signal 240 may cause a second quantum state transition 274 (via a resonance phenomenon associated with QHO) from the first excited state 264 to the second excited state 266. Accordingly, the parasitic coupling of the first control signal 218 to the second qubit 220 may cause a transition (via a resonance phenomenon associated with QHO) of the second qubit 220 from a computational subspace to an excited subspace. The induced signal 240 may generate a qubit error from this leakage into the excited subspace and/or other effects associated with the crosstalk between the first qubit 200 and the second qubit 220.

Accordingly, the total control signal provided to the second qubit 220 includes the superposition of the second control signal 238 and the induced signal 240: V_{T}(t)=V₂(t)+V_{P}(t)=V₁·cos cos(ω₁·t+ϕ₁)+|r|V₁·cos cos(ω₁·t+ϕ₁+δ_{ϕ}), where the subscript T indicates the total signal provided to the second qubit 220. Note that, although not explicitly in FIG. 2C, the second control signal 238 may induce an additional induced signal on the first control line 204. Furthermore, in some embodiments, V₂=0 or V₁=0. That is, in some embodiments, only one of the two qubits 200/220 is being actively driven by a control signal. For instance, the second control signal 238 may be absent, and thus the total signal transmitted to the second qubit 220 is the induced signal 240, e.g., V_{T}(t)=V_{P}(t)=|r|V₁·cos cos(ω₁·t+ϕ₁+δ_{ϕ}).

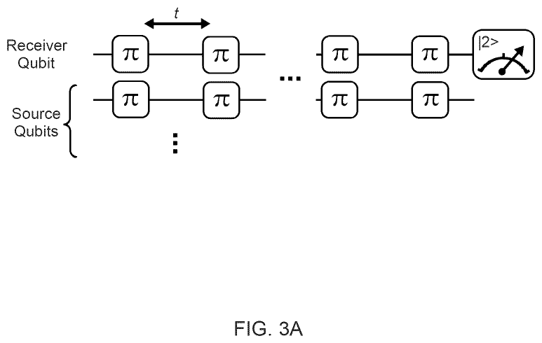

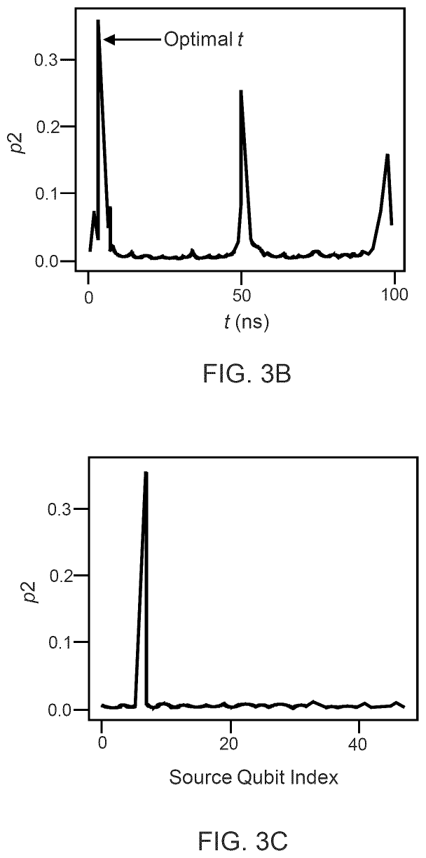

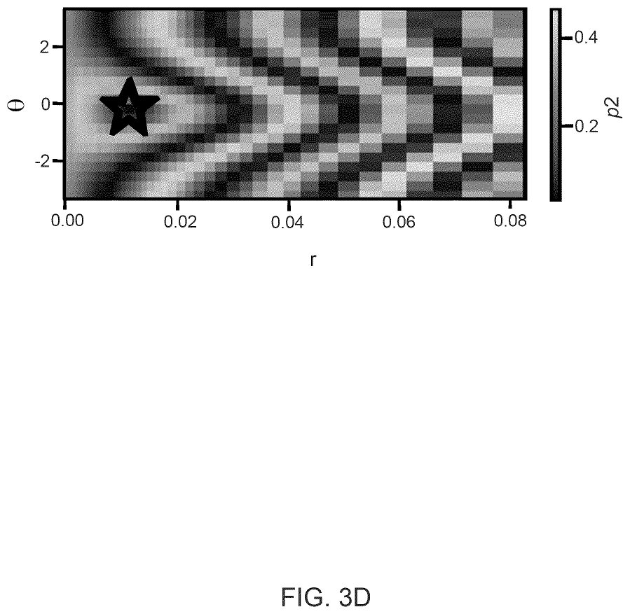

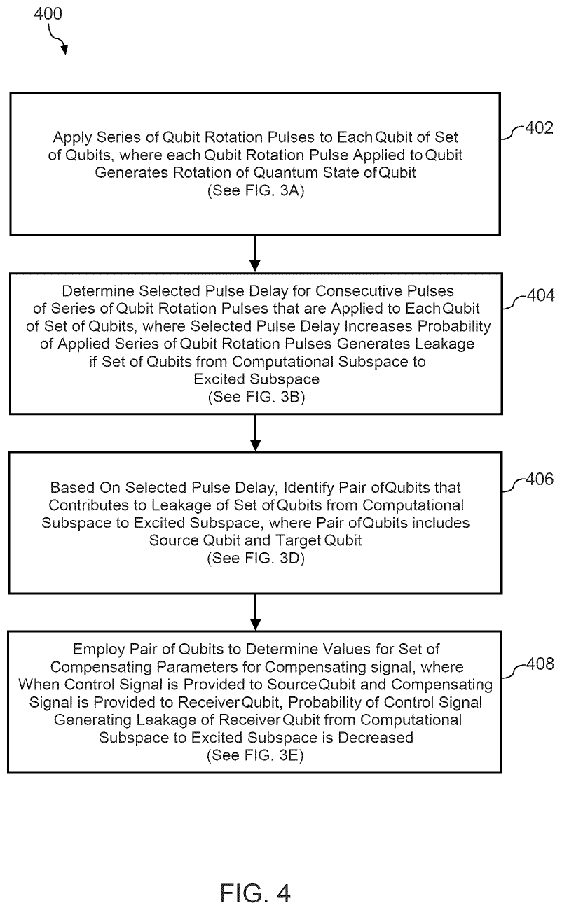

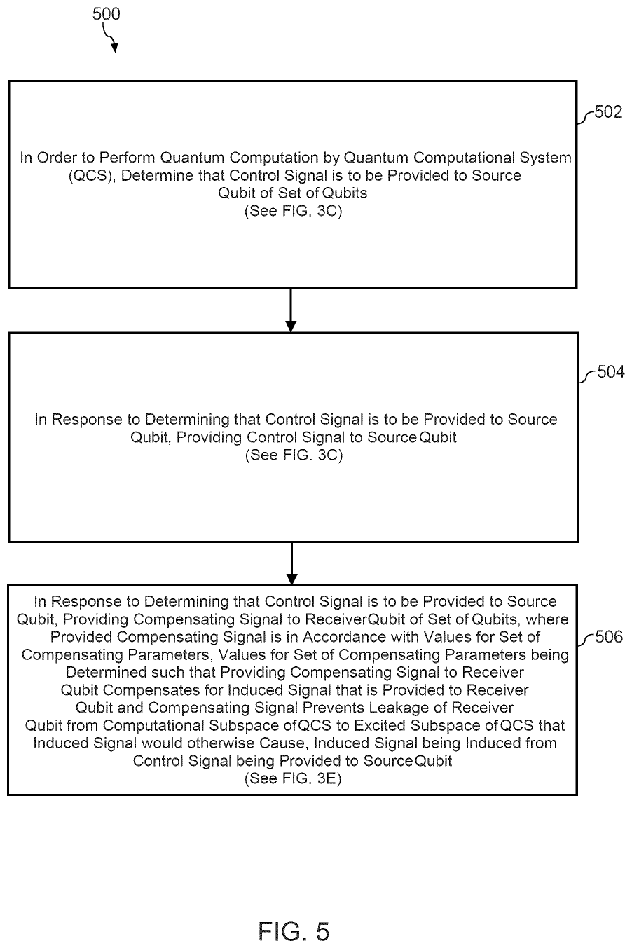

FIG. 2E depicts a mitigation of the induced leakage out of a computational subspace of FIG. 2D via an application of a compensating signal 242 to the second qubit 220, according to various embodiments. More specifically, in response to providing the first control signal 218 to the first qubit 200, and the induction of the induced signal 240 that is transmitted to the second qubit, the second microwave drive 222 provides a compensating signal 242 to the second qubit 220. That is, the compensating signal 242 is transmitted along the second control line 224 and to the second qubit 220. The compensating signal is tuned and/or calibrated to at least partially compensate for and/or at least partially cancel out the effects of the induced signal 240. The functional form of the compensating signal 242 is: V_{C}(t)=|r|V₁·cos cos(ω₁·t+ϕ₁+δ_{ϕ}+π), where the subscript C indicates the compensating and/or canceling effects of the compensating signal 242. Note that periodic functions (e.g., sin sin and cos cos) are anti-symmetric under w rotations (or phase shifts). Accordingly, the superposition of the induced signal 240 and the compensating signal 242 is at least approximately zero, e.g., V_{P}(t)+V_{C}(t)≈0. Thus, compensating signal 242 may at least partially cancel out qubit crosstalk-induced errors. Accordingly, compensating signal 242 may be referred to as a cancelling signal (or tone). FIGS. 3A-3D discuss a Ramsey interferometry-based method for calibrating such compensating signals for the set of qubits employed by a QCS (e.g., quantum computing system 100 of FIG. 1).

Note that the control signals, the induced signals, and the compensating signals may be modeled via complex functions. Manipulating functional forms of periodic signals may be easier when transformed onto the complex plane, via Euler's formula. It may be understood that the real signals, when represented as a complex function may be interpreted as the purely real or the purely imaginary component of the complex function. For instance, the first control signal 218 may be represented as: V₁(t)=|V₁|·e^{i·(ω}^{₁}^{·t+ϕ}^{₁}⁾ and the compensating signal 242 may be represented as: V_{C}(t)=V₁(t)·|r|·e^{i·θ}, where θ≡δ_{ϕ}+π. FIGS. 3A-3D demonstrate a Ramsey interferometry-based method for determining (or calibrating) values for the set of compensating parameters (e.g., (r, θ)) for pairs of qubits of the set of qubits implemented and/or employed by a QCS (e.g., quantum computing system 100 of FIG. 1). The set of compensating parameters includes at least a first parameter corresponding to a magnitude of the compensating signal (e.g., r) and a second parameter corresponding to a phase of the compensating signal (e.g., θ).

FIG. 3A depicts a Ramsey error filter pulse sequence applied to qubits to calibrate compensating signals for the mitigation of qubit crosstalk-induced errors, in accordance with various embodiments. In FIG. 3A, a series of qubit rotation pulses are applied to at least two qubits (e.g., at least one receiver qubit and at least one source qubit) of the set of qubits. Each qubit rotation pulse of the series of qubit rotation pulses applied to a qubit generates a rotation (e.g., a if rotation) of a quantum state of the qubit. Note that the sequence of pulses may be simultaneously applied to multiple “source” (or antagonist) qubits to determine the effects on the at least one receiver qubit. In practice, the sequence of applied pulses may be simultaneously applied to all qubits of the set of qubits. As shown in FIG. 3A, consecutive pulses of the series of pulses are separated by a delay time (t). The pulses may be Ramsey error filter pulses. The sequence (or series) of Ramsey error filter pulses may consist of π rotation pulses separated by a variable delay t. A π rotation pulse applied to a qubit may generate a rotation about at least one of an x-axis or a y-axis of a Bloch sphere representation of the quantum state of the qubit. For example, a π rotation pulse may generate the quantum state transition |0 [symbol] →|1 [symbol] or the quantum state transition |1 [symbol] →|0 [symbol] . Such rotations may generate a resonance effect that results in a coherent leakage from the computational subspace to the excited subspace for the qubit.

The application of the sequence of pulses may be repeated several times to amplify the coherent leakage, which may be observed by direct measurement of the quantum state of the one or more receiver qubits. A measurement of |2 [symbol] (or higher excited states) indicates that the qubit has transitioned to an excited state that is outside the computational subspace. For certain delay times t, this sequence amplifies the coherent crosstalk leakage to facilitate the calibration. This amplification can be understood as a result of constructive interference between the leakage amplitudes induced by successive pulses.

That is, FIG. 3A shows iteratively providing a series of qubit rotation pulses to at least a portion of the qubits of the set of qubits. During each iteration of providing the series of qubit rotation pulses, a pulse delay between the consecutive pulses of the series of qubit rotation pulses is held constant. The pulse delay is varied between consecutive iterations of providing the series of qubit rotation pulses to the qubits. A window of pulse delay values is swept over during iteratively providing the series of qubit rotation pulses to each qubit of the set of qubits. In response to each iteration of providing the series of qubit rotation pulses to the qubits, the quantum state of at least a portion of the qubits may be measured. Each iteration corresponds to a specific value of the pulse delay within the window of pulse delay values.

In response to measuring the quantum state of each qubit of the set of qubits for the iteration corresponding to the specific pulse delay, a probability of generating a transition of the quantum states of the set of qubits from a ground state or a first excited state to one or more higher excited states for the specific pulse delay is measured. The probability may be referred to as a leakage probability (p2). The leakage probability (e.g., p2) may be measured as the fraction of qubits of the set of qubits that have been transitioned to |2 [symbol] (or higher excited stated) via the application of the series of pulses. The leakage probability may be measured as a function pulse delay.

FIG. 3B shows representative data from the Ramsey error filter vs delay time t. The plot of FIG. 3B shows the measurement of the leakage probability (e.g., p2) as a function of the pulse delay (e.g., t). This data may be taken while driving all qubits in parallel to minimize data acquisition time. More specifically, the plot of FIG. 3B shows leakage probability p2 vs t during the Ramsey error filter. The t that at least approximately maximizes the leakage probability (e.g., the optimal pulse delay, as indicated as optimal t in the plot) is identified. The optimal pulse delay may be identified as the pulse delay of the window of pulse delays that at least approximately maximizes the probability of generating the transition of the quantum states of the set of qubits from the first existed state to the one or more higher excited states. The optimal pulse delay and/or the optimal t may be referred to throughout as a selected pulse array.

The optimal pulse delay is used throughout the remainder of the calibration sequence. That is, for the next steps in the calibrations (as shown in FIGS. 3C-3D), t is held fixed at the value that at least approximately maximizes the leakage population and/or leakage probability (e.g., p2). More specifically, the plot of FIG. 3B shows a determination of an optimal pulse delay for consecutive pulses of the series of qubit rotation pulses that are applied to the qubits. The optimal pulse delay increases a probability (e.g., at least approximately maximizes the probability) of the applied series of qubit rotation pulses generating a leakage of the set of qubits from the computational subspace of a QCS (or qubit) to an excited subspace of the QCS (or the qubit). The leakage of the receiver qubit from the computational subspace to the excited subspace includes a transition of a quantum state of the receiver qubit from a first excited state to a second excited state (or a higher excited state).

FIG. 3C shows typical output of the Ramsey error filter at optimal t during pairwise operation for all possible pairs that include the receiver qubit. This data identifies the source of the parasitic drive. That is, the plot of FIG. 3C is a plot of p2 vs source qubit during pairwise operation at optimal t. The peak identifies the dominant source of the leakage. More specifically, the plot shows p2 vs source qubit during pairwise operation at optimal t. The peak identifies the dominant source. p2 after Ramsey error filter during pairwise operation with the dominant source vs r and θ, the magnitude and phase of the compensation tone used to null the crosstalk leakage. The data employed to generate the plot of FIG. 3C may be acquired by selecting a qubit from the set of qubits as a target qubit, and for each data point on the x-axis, selecting another qubit as the source qubit. Accordingly, the plot of FIG. 3C may be employed to determine the greatest source of leakage (into the excited subspace) for a particular target qubit. As such, to characterize the entire set of qubits, the plot of FIG. 3C may be generated for each qubit of the set of qubits. The qubit corresponding to the plot of FIG. 3C may be considered as a target qubit. The data may be acquired by providing a sequence of qubit rotation pulses to the pair of qubits, where the pulse delay is set to the optimal pulse delay (or a selected pulse delay) found via the plot of FIG. 3B.

The plot of FIG. 3C may be employed to identify, based on the optimal pulse delay (or the selected pulse delay), a pair of qubits of the set of qubits that contributes to the leakage of the set of qubits from the computational subspace to the excited subspace. The pair of qubits includes a source qubit and a receiver qubit. Note that each data point along the x-axis corresponds to a separate pair of qubits, but the target qubit is held constant along the x-axis. Accordingly, each data point along the x-axis may correspond to a difference source qubit of the qubit pair. As noted above, the plot of FIG. 3C may be generated for each qubit of the set of qubits. The qubit corresponding to the plot of FIG. 3C may be employed as the target qubit of the pair of qubits associated with every data point along the x-axis.

More specifically, the pair of qubits (with a specific receiver qubit) may be identified by generating the plot of FIG. 3D for each possible specific receiver qubit. Each possible pair of qubits from a set of all possible pairings of qubits may be iteratively selected. Each selected possible pair of qubits includes a first qubit (e.g., a source qubit) and a second qubit (e.g., a receiver qubit). For each selected possible pair of qubits, a series of qubit rotation pulses may be provided, in accordance with (e.g., based on) the optimal (or selected) pulse delay, to a least one of the first qubit and the second qubit of the selected possible pair of qubits. In response to providing the series of qubit rotation pulses to each of the first qubit and the second qubit, a quantum state of at least one of the first qubit and the second qubit of the selected possible pair of qubits may be measured. For each selected possible pair of qubits and based on measuring the quantum state of each of the first qubit and the second qubit, the probability of the provided series of qubit rotation pulses, in accordance (e.g., based on) with the optimal pulse delay, generating a transition of the quantum state of at least one of the first qubit or the second qubits to a second excited state (or higher excited state) may be measured. The pair of qubits of the set of qubits of the set of qubits that at least approximately maximizes the probability of the provided series of qubit rotation pulses in accordance (e.g., based on) with the optimal pulse delay generating the transition of the quantum state of the at least one of the first qubit or the second qubits to the second excited state may be identified, as shown in the plot of FIG. 3C. The identified pair of qubits may be the pair of qubits from all possible pairings of the set of qubits that dominates the leakage of the set of qubits from the computational subspace to the excited subspace.

FIG. 3D shows p2 on the receiver qubit during pairwise operation with the dominant source qubit at optimal t vs the amplitude r and phase θ of the compensation tone. The star indicates the optimal r and θ to mitigate crosstalk induced leakage. That is, the phases space of the plot of FIG. p2 vs source qubit during pairwise operation at optimal t. The peak identifies the dominant source. p2 after Ramsey error filter during pairwise operation with the dominant source vs r and θ, the magnitude and phase of the compensation tone used to null the crosstalk leakage.

The plot of FIG. 3D may be employed to determine values for the set of compensating parameters for the compensating signal. When a control signal is provided to the source qubit and the compensating signal is provided to the receiver qubit, a probability of the control signal generating a leakage of the receiver qubit from the computational subspace to the excited subspace is decreased (e.g., minimized). The values for the set of compensating parameters for the compensating signal are selected from a space of possible values for the set of compensating parameters, as shown in the plot of FIG. 3D. The selected values being the values from the space of possible values that minimize the probability of the control signal generating a leakage of the receiver qubit from the computational subspace to the excited subspace.

In some embodiments, after calibrating the compensating signal, a quantum computation may be performed by the QCS. In order to perform the quantum computation by the QCS, it may be determined that the control signal is to be provided to a first qubit (e.g., a source qubit). In response to determining that the control signal is to be provided to the source qubit, the control signal may be provided to the source qubit. Also in response to determining that the control signal is to be provided to the source qubit, a compensating signal may be provided to a second qubit (e.g., a receiver qubit). The provided compensating signal may be in accordance (e.g., based on) with the determined values for the set of compensating parameters for the qubit pair. Providing the compensating signal to the receiver qubit may compensate for an induced signal that is provided to the receiver qubit. The compensating signal may prevent the leakage of the receiver qubit from the computational subspace to the excited subspace that the induced signal would otherwise cause. The induced signal may be induced from the control signal being provided to the source qubit.

### Methods

FIGS. 4-5 depict operations performed in a particular order for purposes of illustration and discussion. Those of ordinary skill in the art, using the disclosures provided herein, will understand that operations of any of the methods described herein can be expanded, include steps not illustrated, omitted, rearranged, and/or modified in various ways without deviating from the scope of the present disclosure. Method 400 of FIG. 4 and method 500 of FIG. 5 may be implemented using any suitable quantum computing system, such as the system described in FIG. 1.

FIG. 4 provides a flowchart for a method 400 of calibrating compensating signals for the mitigation of qubit crosstalk-induced errors, in accordance with various embodiments. Method 400 begins, at block 402, where a series of qubit rotation pulses are applied to each qubit of a set of qubits. Each qubit rotation pulse is applied to a qubit generates a rotation of a quantum state of the qubit. The application of a series of qubit rotation pulses to a qubit is discussed at least in conjunction with FIG. 3A. Each qubit rotation pulse of the series of rotation pulses applied to the qubit may be a pi-rotation pulse. The rotation of the quantum state of the qubit is a rotation about at least one of an x-axis or a y-axis of a Bloch sphere representation of the quantum state of the qubit

At block 404, a selected pulse delay for consecutive pulses of a series of qubit rotation pulses that are applied to each qubit of the set of qubits is determined. The determination of the selected pulse delay is discussed at least in conjunction with FIG. 3A. However, briefly here, the selected pulse delay increases (e.g., at least approximately maximizes) a probability of the applied series of qubit rotation pulses generating a leakage of the set of qubits from a computational subspace of the QCS to an excited subspace of the QCS. The selected pulse delay may be an optimal pulse delay. As an optimal pulse delay, the selected pulse delay may at least approximately maximize the probability of the applied series of qubit rotation pulses generating a leakage of at least a portion of the set of qubits from a computational subspace of the QCS to an excited subspace of the QCS. Note that the terms “pulse delay” and “time delay” may be used throughout interchangeably.

At block 406, based on the selected pulse delay, a pair of qubits of the set of qubits that contributes (e.g., at least approximately maximized) to the leakage of the set of qubits from the computational subspace to the excited subspace is identified. The identified pair of qubits may include a source qubit and a receiver qubit. Identifying such a pair of qubits is discussed at least in conjunction with FIG. 3C. The identified pair of qubits that contributes to the leakage of the set of qubits from the computational subspace to the excited subspace may be a pair of qubits from all possible pairings of the set of qubits that dominates the leakage of the set of qubits from the computational subspace to the excited subspace.

At block 408, the identified pair of qubits is employed to determine values for a set of compensating parameters for a compensating signal. Determining the values for the set of compensating parameters is discussed at least in conjunction with FIG. 3D. When a control signal is provided to the source qubit and the compensating signal is provided to the receiver qubit, a probability of the control signal generating a leakage of the receiver qubit from the computational subspace to the excited subspace is decreased (e.g., minimized). The leakage of the receiver qubit from the computational subspace to the excited subspace may include a transition of a quantum state of the receiver qubit from a first excited state to a second excited state. The set of compensating parameters may include a first parameter corresponding to a magnitude of the compensating signal and a second parameter corresponding to a phase of the compensating signal.

FIG. 5 provides a flowchart for a method 500 for mitigating qubit crosstalk-induced errors in a quantum computing system (QCS), in accordance with various embodiments. Method 500 begins, at block 502, where in order to perform a quantum computation by the QCS, it is determining that a control signal is to be provided to a source qubit of the set of qubits. At block 504, and in response to determining that the control signal is to be provided to the source qubit, the control signal may be provided to the source qubit. At block 506, and in response to determining that the control signal is to be provided to the source qubit, a compensating signal is provided to a receiver qubit of the set of qubits. The provided compensating signal is in accordance with (e.g., based on) values for a set of compensating parameters. The values for the set of compensating parameters being determined such that providing the compensating signal to the receiver qubit compensates for an induced signal that is provided to the receiver qubit. The compensating signal prevents a leakage of the receiver qubit from a computational subspace of the QCS to an excited subspace of the QCS that the induced signal would otherwise cause. The induced signal being induced from the control signal being provided to the source qubit.

### Additional Embodiments

Implementations of the digital, classical, and/or quantum subject matter and the digital functional operations and quantum operations described in this specification can be implemented in digital electronic circuitry, suitable quantum circuitry or, more generally, quantum computational systems, in tangibly-implemented digital and/or quantum computer software or firmware, in digital and/or quantum computer hardware, including the structures disclosed in this specification and their structural equivalents, or in combinations of one or more of them. The term “quantum computing systems” may include, but is not limited to, quantum computers/computing systems, quantum information processing systems, quantum cryptography systems, or quantum simulators.

Implementations of the digital and/or quantum subject matter described in this specification can be implemented as one or more digital and/or quantum computer programs, i.e., one or more modules of digital and/or quantum computer program instructions encoded on a tangible non-transitory storage medium for execution by, or to control the operation of, data processing apparatus. The digital and/or quantum computer storage medium can be a machine-readable storage device, a machine-readable storage substrate, a random or serial access memory device, one or more qubits/qubit structures, or a combination of one or more of them. Alternatively or in addition, the program instructions can be encoded on an artificially-generated propagated signal that is capable of encoding digital and/or quantum information (e.g., a machine-generated electrical, optical, or electromagnetic signal) that is generated to encode digital and/or quantum information for transmission to suitable receiver apparatus for execution by a data processing apparatus.

The terms quantum information and quantum data refer to information or data that is carried by, held, or stored in quantum systems, where the smallest non-trivial system is a qubit, i.e., a system that defines the unit of quantum information. It is understood that the term “qubit” encompasses all quantum systems that may be suitably approximated as a two-level system in the corresponding context. Such quantum systems may include multi-level systems, e.g., with two or more levels. By way of example, such systems can include atoms, electrons, photons, ions or superconducting qubits. In many implementations the computational basis states are identified with the ground and first excited states, however it is understood that other setups where the computational states are identified with higher level excited states (e.g., qudits) are possible.

The term “data processing apparatus” refers to digital and/or quantum data processing hardware and encompasses all kinds of apparatus, devices, and machines for processing digital and/or quantum data, including by way of example a programmable digital processor, a programmable quantum processor, a digital computer, a quantum computer, or multiple digital and quantum processors or computers, and combinations thereof. The apparatus can also be, or further include, special purpose logic circuitry, e.g., an FPGA (field programmable gate array), or an ASIC (application-specific integrated circuit), or a quantum simulator, i.e., a quantum data processing apparatus that is designed to simulate or produce information about a specific quantum system. In particular, a quantum simulator is a special purpose quantum computer that does not have the capability to perform universal quantum computation. The apparatus can optionally include, in addition to hardware, code that creates an execution environment for digital and/or quantum computer programs, e.g., code that constitutes processor firmware, a protocol stack, a database management system, an operating system, or a combination of one or more of them.

A digital or classical computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a digital computing environment. A quantum computer program, which may also be referred to or described as a program, software, a software application, a module, a software module, a script, or code, can be written in any form of programming language, including compiled or interpreted languages, or declarative or procedural languages, and translated into a suitable quantum programming language, or can be written in a quantum programming language, e.g., QCL, Quipper, Cirq, etc.

A digital and/or quantum computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A digital and/or quantum computer program can be deployed to be executed on one digital or one quantum computer or on multiple digital and/or quantum computers that are located at one site or distributed across multiple sites and interconnected by a digital and/or quantum data communication network. A quantum data communication network is understood to be a network that may transmit quantum data using quantum systems, e.g. qubits. Generally, a digital data communication network cannot transmit quantum data, however a quantum data communication network may transmit both quantum data and digital data.

The processes and logic flows described in this specification can be performed by one or more programmable digital and/or quantum computers, operating with one or more digital and/or quantum processors, as appropriate, executing one or more digital and/or quantum computer programs to perform functions by operating on input digital and quantum data and generating output. The processes and logic flows can also be performed by, and apparatus can also be implemented as, special purpose logic circuitry, e.g., an FPGA or an ASIC, or a quantum simulator, or by a combination of special purpose logic circuitry or quantum simulators and one or more programmed digital and/or quantum computers.

For a system of one or more digital and/or quantum computers or processors to be “configured to” or “operable to” perform particular operations or actions means that the system has installed on it software, firmware, hardware, or a combination of them that in operation cause the system to perform the operations or actions. For one or more digital and/or quantum computer programs to be configured to perform particular operations or actions means that the one or more programs include instructions that, when executed by digital and/or quantum data processing apparatus, cause the apparatus to perform the operations or actions. A quantum computer may receive instructions from a digital computer that, when executed by the quantum computing apparatus, cause the apparatus to perform the operations or actions.

Digital and/or quantum computers suitable for the execution of a digital and/or quantum computer program can be based on general or special purpose digital and/or quantum microprocessors or both, or any other kind of central digital and/or quantum processing unit. Generally, a central digital and/or quantum processing unit will receive instructions and digital and/or quantum data from a read-only memory, or a random access memory, or quantum systems suitable for transmitting quantum data, e.g. photons, or combinations thereof.

Some example elements of a digital and/or quantum computer are a central processing unit for performing or executing instructions and one or more memory devices for storing instructions and digital and/or quantum data. The central processing unit and the memory can be supplemented by, or incorporated in, special purpose logic circuitry or quantum simulators. Generally, a digital and/or quantum computer will also include, or be operatively coupled to receive digital and/or quantum data from or transfer digital and/or quantum data to, or both, one or more mass storage devices for storing digital and/or quantum data, e.g., magnetic, magneto-optical disks, or optical disks, or quantum systems suitable for storing quantum information. However, a digital and/or quantum computer need not have such devices.

Digital and/or quantum computer-readable media suitable for storing digital and/or quantum computer program instructions and digital and/or quantum data include all forms of non-volatile digital and/or quantum memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks; and quantum systems, e.g., trapped atoms or electrons. It is understood that quantum memories are devices that can store quantum data for a long time with high fidelity and efficiency, e.g., light-matter interfaces where light is used for transmission and matter for storing and preserving the quantum features of quantum data such as superposition or quantum coherence.

Control of the various systems described in this specification, or portions of them, can be implemented in a digital and/or quantum computer program product that includes instructions that are stored on one or more tangible, non-transitory machine-readable storage media, and that are executable on one or more digital and/or quantum processing devices. The systems described in this specification, or portions of them, can each be implemented as an apparatus, method, or electronic system that may include one or more digital and/or quantum processing devices and memory to store executable instructions to perform the operations described in this specification.

While this specification contains many specific implementation details, these should not be construed as limitations on the scope of what may be claimed, but rather as descriptions of features that may be specific to particular implementations. Certain features that are described in this specification in the context of separate implementations can also be implemented in combination in a single implementation. Conversely, various features that are described in the context of a single implementation can also be implemented in multiple implementations separately or in any suitable sub combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the implementations described above should not be understood as requiring such separation in all implementations, and it should be understood that the described program components and systems can generally be integrated together in a single software product or packaged into multiple software products.

Particular implementations of the subject matter have been described. Other implementations are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method for operating a quantum computing system (QCS) comprising a set of qubits, the method comprising:
determining a selected pulse delay for consecutive pulses of a series of qubit rotation pulses that are applied to each qubit of the set of qubits, wherein each qubit rotation pulse of the series of qubit rotation pulses applied to a qubit of the set of qubits generates a rotation of a quantum state of the qubit and the selected pulse delay increases a probability of the series of qubit rotation pulses generating a leakage of at least a portion of the set of qubits from a computational subspace of the QCS to an excited subspace of the QCS; and
identifying, based on the selected pulse delay, a pair of qubits of the set of qubits that contributes to the leakage of the set of qubits from the computational subspace to the excited subspace, wherein the pair of qubits includes a source qubit and a receiver qubit; and
employing the pair of qubits to determine values for a set of compensating parameters for a compensating signal, wherein when a control signal is provided to the source qubit and the compensating signal is provided to the receiver qubit, a probability of the control signal generating a leakage of the receiver qubit from the computational subspace to the excited subspace is decreased.

2. The method of claim 1, further comprising:
determining that the control signal is to be provided to the source qubit;
in response to determining that the control signal is to be provided to the source qubit, providing the control signal to the source qubit; and
in response to determining that the control signal is to be provided to the source qubit, providing the compensating signal to the receiver qubit, wherein the compensating signal is based at least in part on the values for the set of compensating parameters.

3. The method of claim 1, wherein the set of compensating parameters includes a first parameter corresponding to a magnitude of the compensating signal and a second parameter corresponding to a phase of the compensating signal.

4. The method of claim 1, wherein each qubit rotation pulse of the series of qubit rotation pulses applied to the qubit is a pi-rotation pulse that generates a rotation of the quantum state of the qubit and the rotation is about at least one of an x-axis or a y-axis of a Bloch sphere representation of the quantum state of the qubit.

5. The method of claim 1, wherein the leakage of the receiver qubit from the computational subspace to the excited subspace includes a transition of a quantum state of the receiver qubit from a first excited state to a second excited state.

6. The method of claim 1, wherein determining the selected pulse delay comprises:
iteratively providing the series of qubit rotation pulses to each qubit of the set of qubits, wherein during each iteration of providing the series of qubit rotation pulses, a pulse delay between the consecutive pulses of the series of qubit rotation pulses is held constant, and the pulse delay is varied between consecutive iterations of providing the series of qubit rotation pulses to each qubit of the set of qubits such that a window of pulse delays is swept over during iteratively providing the series of qubit rotation pulses to each qubit of the set of qubits;
in response to each iteration of providing the series of qubit rotation pulses to each qubit of the set of qubits, measuring a quantum state of each qubit of the set of qubits, wherein the iteration corresponds to a specific pulse delay of the window of pulse delays;
in response to measuring the quantum state of each qubit of the set of qubits for the iteration corresponding to the specific pulse delay, determining a probability of generating a transition of the quantum states of the set of qubits from a first excited state to one or more higher excited states for the specific pulse delay; and
identifying the selected pulse delay as a pulse delay of the window of pulse delays that increases the probability of generating the transition of the quantum states of the set of qubits from the first excited state to the one or more higher excited states.

7. The method of claim 1, wherein the pair of qubits that contributes to the leakage of the set of qubits from the computational subspace to the excited subspace is a pair of qubits from all possible pairings of the set of qubits that dominates the leakage of the portion of the set of qubits from the computational subspace to the excited subspace.

8. The method of claim 1, wherein identifying the pair of qubits that contributes to the leakage of the set of qubits from the computational subspace to the excited subspace comprises:
iteratively selecting each possible pair of qubits from a set of all possible pairings of qubits, wherein each selected possible pair of qubits includes a first qubit and a second qubit;
for each selected possible pair of qubits, providing the series of qubit rotation pulses in accordance with the selected pulse delay to each of the first qubit and the second qubit of the selected possible pair of qubits;
in response to providing the series of qubit rotation pulses to each of the first qubit and the second qubit, measuring a quantum state of each of the first qubit and the second qubit of the selected possible pair of qubits;
for each selected possible pair of qubits and based on measuring the quantum state of each of the first qubit and the second qubit, determining a probability of the series of qubit rotation pulses in accordance with the selected pulse delay generating a transition of the quantum state of at least one of the first qubit or the second qubits to a second excited state; and
identifying the pair of qubits of the set of qubits of the set of qubits that maximizes the probability of the series of qubit rotation pulses in accordance with the selected pulse delay generating the transition of the quantum state of the at least one of the first qubit or the second qubits to the second excited state.

9. The method of claim 1, wherein the values for the set of compensating parameters for the compensating signal are selected from a space of possible values for the set of compensating parameters, the selected values being values from the space of possible values that minimize the probability of the control signal generating a leakage of the receiver qubit from the computational subspace to the excited subspace.

10. The method of claim 1, wherein providing the compensating signal to the receiver qubit compensates for an induced signal that is provided to the receiver qubit such that the compensating signal prevents the leakage of the receiver qubit from the computational subspace to the excited subspace that the induced signal would otherwise cause, the induced signal being induced from the control signal being provided to the source qubit.

11. A method for operating a quantum computing system (QCS) comprising a set of qubits, the method comprising:
determining that a control signal is to be provided to a source qubit of the set of qubits;
in response to determining that the control signal is to be provided to the source qubit, providing the control signal to the source qubit; and
in response to determining that the control signal is to be provided to the source qubit, providing a compensating signal to a receiver qubit of the set of qubits, wherein the provided compensating signal is based at least in part on values for a set of compensating parameters, the values for the set of compensating parameters being determined such that providing the compensating signal to the receiver qubit compensates for an induced signal that is provided to the receiver qubit and the compensating signal prevents a leakage of the receiver qubit from a computational subspace of the QCS to an excited subspace of the QCS, the induced signal being induced from the control signal being provided to the source qubit.

12. The method of claim 11, further comprising:
determining the values for the set of compensating parameters based on a Ramsey error filter procedure.

13. The method of claim 12, wherein the Ramsey error filter procedure includes actions, the actions comprising:
determining a selected pulse delay for consecutive pulses of a series of qubit rotation pulses that are applied to each qubit of the set of qubits, wherein each qubit rotation pulse of the series of qubit rotation pulses applied to a qubit of the set of qubits generates a rotation of a quantum state of the qubit and the selected pulse delay increases a probability of the series of qubit rotation pulses generating a leakage of the set of qubits from a computational subspace of the QCS to an excited subspace of the QCS;
identifying, based on the selected pulse delay, a pair of qubits of the set of qubits that contributes to the leakage of the set of qubits from the computational subspace to the excited subspace, wherein the pair of qubits includes the source qubit and the receiver qubit; and
employing the pair of qubits to determine the values for the set of compensating parameters for the compensating signal, wherein when the control signal is provided to the source qubit and the compensating signal is provided to the receiver qubit, a probability of the control signal generating a leakage of the receiver qubit from the computational subspace to the excited subspace is decreased.

14. The method of claim 13, wherein each qubit rotation pulse of the series of qubit rotation pulses applied to the qubit is a pi-rotation pulse that generates a rotation of the quantum state of the qubit and the rotation is about at least one of an x-axis or a y-axis of a Bloch sphere representation of the quantum state of the qubit.

15. The method of claim 13, wherein the leakage of the receiver qubit from the computational subspace to the excited subspace includes a transition of a quantum state of the receiver qubit from a first excited state to a second excited state.

16. The method of claim 13, wherein determining the selected pulse delay comprises:
iteratively providing the series of qubit rotation pulses to each qubit of the set of qubits, wherein during each iteration of providing the series of qubit rotation pulses, a pulse delay between the consecutive pulses of the series of qubit rotation pulses is held constant, and the pulse delay is varied between consecutive iterations of providing the series of qubit rotation pulses to each qubit of the set of qubits such that a window of pulse delays is swept over during iteratively providing the series of qubit rotation pulses to each qubit of the set of qubits;
in response to each iteration of providing the series of qubit rotation pulses to each qubit of the set of qubits, measuring the quantum state of each qubit of the set of qubits, wherein the iteration corresponds to a specific pulse delay of the window of pulse delays;
in response to measuring the quantum state of each qubit of the set of qubits for the iteration corresponding to the specific pulse delay, determining a probability of generating a transition of the quantum states of the set of qubits from a first excited state to one or more higher excited states for the specific pulse delay; and
identifying the selected pulse delay as a pulse delay of the window of pulse delays that maximizes the probability of generating the transition of the quantum states of the set of qubits from the first excited state to the one or more higher excited states.

17. The method of claim 13, wherein identifying the pair of qubits that contributes to the leakage of the set of qubits from the computational subspace to the excited subspace comprises:
iteratively selecting each possible pair of qubits from a set of all possible pairings of qubits, wherein each selected possible pair of qubits includes a first qubit and a second qubit;
for each selected possible pair of qubits, providing the series of qubit rotation pulses in accordance with the selected pulse delay to each of the first qubit and the second qubit of the selected possible pair of qubits;
in response to providing the series of qubit rotation pulses to each of the first qubit and the second qubit, measuring a quantum state of each of the first qubit and the second qubit of the selected possible pair of qubits;
for each selected possible pair of qubits and based on measuring the quantum state of each of the first qubit and the second qubit, determining a probability of the provided series of qubit rotation pulses in accordance with the selected pulse delay generating a transition of the quantum state of at least one of the first qubit or the second qubits to a second excited state; and
identifying the pair of qubits of the set of qubits of the set of qubits that maximizes the probability of the provided series of qubit rotation pulses in accordance with the selected pulse delay generating the transition of the quantum state of the at least one of the first qubit or the second qubits to the second excited state.

18. The method of claim 11, wherein the values for the set of compensating parameters for the compensating signal are selected from a space of possible values for the set of compensating parameters, the selected values being values from the space of possible values that decreases a probability of the control signal generating a leakage of the receiver qubit from the computational subspace to the excited subspace.

19. A quantum computing system (QCS), comprising:
a set of qubits;
one or more processors;
one or more memory devices, the one or more memory devices storing computer-readable instructions that when executed by the one or more processors cause the one or more processors to perform operations comprising:
determining that a control signal is to be provided to a source qubit of the set of qubits;
in response to determining that the control signal is to be provided to the source qubit, providing the control signal to the source qubit; and
in response to determining that the control signal is to be provided to the source qubit, providing a compensating signal to a receiver qubit of the set of qubits, wherein the provided compensating signal is based at least in part on values for a set of compensating parameters, the values for the set of compensating parameters being determined such that providing the compensating signal to the receiver qubit compensates for an induced signal that is provided to the receiver qubit and the compensating signal prevents a leakage of the receiver qubit from a computational subspace of the QCS to an excited subspace of the QCS, the induced signal being induced from the control signal being provided to the source qubit.

20. The QCS of claim 19, the operations further comprising:
determining the values for the set of compensating parameters based on a Ramsey error filter procedure.
